(19) United States
(12) Patent Application Publication
(10) Pub. No.: US 2014/0102573 A1
(43) Pub. Date: Apr. 17, 2014

(54) Air ventilated garment

(71) Applicant: John Larocque, Fort Myers, FL (US)

(72) Inventor: John Larocque, Fort Myers, FL (US)

(21) Appl. No.: 13/573,950

(22) Filed: Oct. 16, 2012

(51) Int. Cl. A41B 9/00; F17D 3/00; A41B 9/06

(52) U.S. Cl. 137/861; 2/69; 2/113

(57) ABSTRACT

The inventive concept is directed to a cooling system incorporated into underwear such as shorts or T-shirts. The cooling system includes a circular tube incorporated into a hem of the above mentioned underwear. The circular tube is placed into the inner surface of the underwear by way of a tunnel sewn into waistline of the shorts or the bottom of the T-shirt. There is a multitude of T-shaped connectors located in strategically predetermined positions. Each of the T-shaped connectors has an air tube extending therefrom. The air tubes are directed downwardly in the case of shorts and are directed upwardly in the case of T-shirts. The air tubes are also located in tunnels sewn into the interior surface of the garment. The circular tube also has an outlet to be connected to a remote source of conditioned air.

### BACKGROUND OF THE INVENTION

The present invention relates, in general, to a personal ventilation apparatus and, in particular, to a personal ventilation system including a ventilation garment which is worn under any regular or professional garment as underwear. A person working or playing in a warm environment for which protective clothing is required, may find the working or playing conditions uncomfortable and may even experience a deterioration in performance or increased fatigue due to the build-up of body heat. Persons participating in a sport, for example such in football, soccer and other outdoor sport environments, wear protective and team indicating protective clothing. This participation also extends to workers in a work place such as automotive repair areas, manufacturing and construction. Firefighters in the fire department are also included.

One known technique for keeping the bodies of the above identified persons cool in such situations has been to employ a coolant chilled garment. A coolant liquid, such as chilled water, is pumped through tubes which are attached to the garment. Such systems are typically closed systems. Cooling by liquid increases the weight of the garment and renders the same quite awkward and cumbersome to wear and greatly increases the cost of such protection. There are other known air cooling garments such as a vest which is simple a lightweight garment. This garment comprises an outer air impermeable layer of material of minimal weight and bulk and an inner layer of air permeable material of minimal weight and bulk. The layers are secured together in a manner that allows air to move between such layers and through the inner permeable layer to the body of the wearer. Such a garment is illustrated in U.S. Pat. No. 5,970,519. Another personal body ventilation system is disclosed in U.S. Pat. No. 5,564,124 which employs a battery powered blower to provide pressure to the interior disposable garment formed by an inner impervious layer and an outer impervious layer. Porous-to-air open celled foam is incorporated into the garment at areas where cooling is desired. Many other garments are known that are cumbersome because they appear to be air-conditioning system carried on the body of the person.

### BRIEF DESCRIPTION OF THE INVENTION

The present invention is a very simple, inexpensive and easy to carry ventilation system that may be incorporated into existing garments, preferably underwear. A main circular tube may be attached to or placed into a hem of a garment, such as the hem in a waistband of briefs or shorts or the bottom hem of a T-shirt. In case of a short or a brief a circular tubing is being attached at the waistline of the short or brief and at least four tubes are depending from the circular tube and each of the tubes is placed in predetermined areas for cooling purposes such as one tube ending in the crotch area, a tube each at side areas at the hips and at least one tube extending down and in between the buttocks. In case of applying the inventive cooling system to a T-shirt, the circular tube is placed in the bottom of the T-shirt hem and at least four upstanding tubes are connected to the circular tube in the hem with each the tubes being placed again into a predetermined areas such that a tube extends under the arm pits of a person, up the front another up the back. The tubes are placed in their respective garments, the short or the T-shirt, by way of tunnels sewn into the garment. Thereby, the tubes may be taken out prior to laundering the garments or in the case that each of the items are worn when no cooling is required or desired. The garments may be worn by any of the persons identified above in the heading of “Background the Invention”. The cooling system is not intended to be used in a continuous manner but only when the person is at rest and relaxing in between tasks. For this purpose, in the case of a football match and when any player is at rest, a specially built bench may be arranged that that is so constructed that several players at rest on the bench may be attached to cooled air outlets on the bench. A fireman, for example, may be attached to a specially constructed cooling tower that can supply cooling air to several persons at once that are attached to it. The cooling tower may be located in a fire station or it may be located on a fire engine truck.

### BRIEF DESCRIPTION OF THE DRAWINGS

FIG. 1 illustrates the basic concept of the cooling tube system;

FIG. 2 shows the front of a brief with tunnels to receive the tubes;

FIG. 3 shows the tunnels on the brief from the back;

FIG. 4 illustrates the basic concept of FIG. 1 which is a reverse of the tubing;

FIG. 5 shows the tubing tunnels applied to a front of a T-shirt;

FIG. 6 shows the tubing tunnels applied to the back of a T-shirt;

FIG. 7 illustrates a bench having a multiple of cooling outlets;

FIG. 8 illustrates a cooling tower having a multiple of cooling outlets.

### DETAILED DESCRIPTION OF THE INVENTION

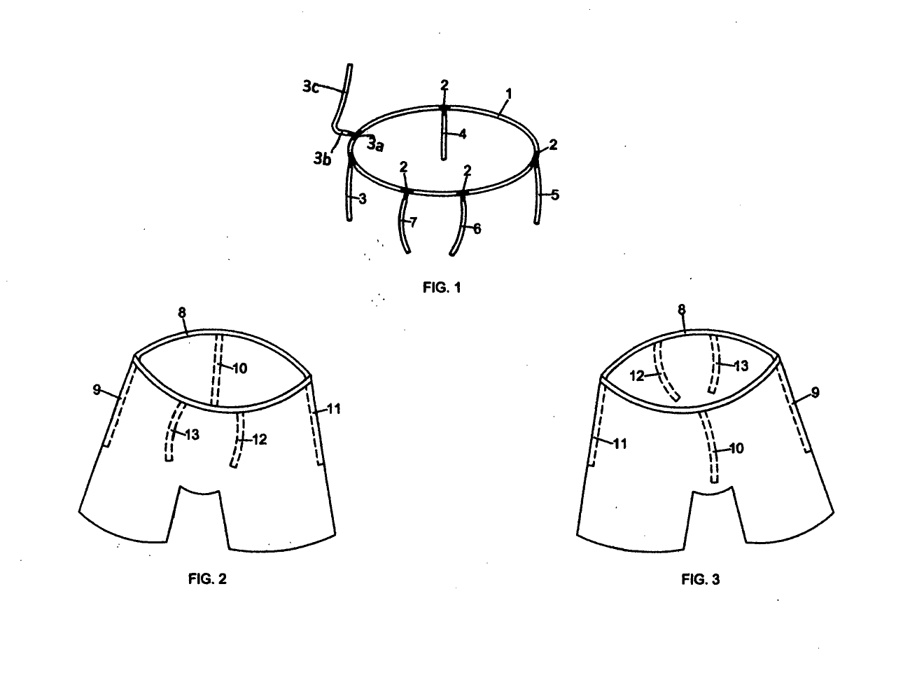

FIG. 1 illustrates the basic air ventilation system. It consists of a circular tube 1 which is being inserted in hem lines of the garments as will be explained below. The circular tube 1 is not continuous but is connected to itself by four T-shaped connectors 2 to make a circle. To each T-shaped connector there is connected tubular element 3, 4, 5, 6 and 7 of a given length. In this FIG. 1, the tubular elements are shown to be depending from the T connector in a downward direction. In another embodiment of the invention the tubular elements are extending upwardly, as will be explained below. At the top of tubular element 3 there is a connector 3a from which the tubular element 3 depends. This connector 3a also has a connector 3b which is being used to connect the circular tube 1 to a supply of air by way of tube 3c, preferably cooled or heated, as the environment requires at the time of use. The tubular elements as well as the circular tube 1 should be about ¼″ diameter and should be somewhat pliable to be able to move with the movement of the garments to present the least obstruction to any movements.

FIGS. 2 and 3 illustrate an underwear in the form of shorts. FIG. 2 shows a front of the shorts having tunnels 9, 10, 11, 12 and 13 incorporated therein by way of sewing. The tube 1 illustrated in FIG. 1 is received in theses tunnels. The tunnels are strategically located. The tunnels 12 and 13, with the air tubes located therein, are pointing to the crotch are of the wearer. The tunnels 9 and 11 are located along the sides, that is, the hip area of the wearer, while the tunnel 10 with the air tube located therein is located in between the buttocks of the wearer. It is believed that the tubes located where they are do somewhat induce the “Coanda Effect”. The “Coanda Effect” is the phenomena in which a jet flow attaches itself to a nearby surface and remains attached even when the surface curves away from the initial jet direction. It is believed that this effect greatly contributes to the comfort of the wearer, whereby this simple and low cost system is highly desirable over the above mentioned cumbersome systems. FIG. 3 is a back view of the underwear shorts of FIG. 2 showing the rear tunnel 10 pointing downwardly between the buttocks of the wearer while the tube 4 of FIG. 1 is located therein.

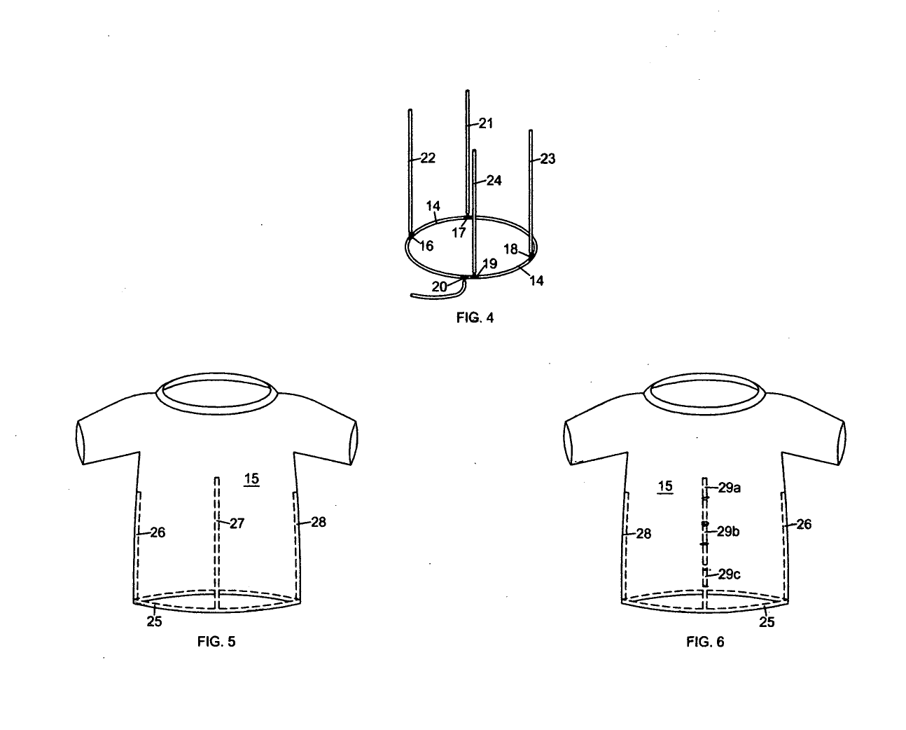

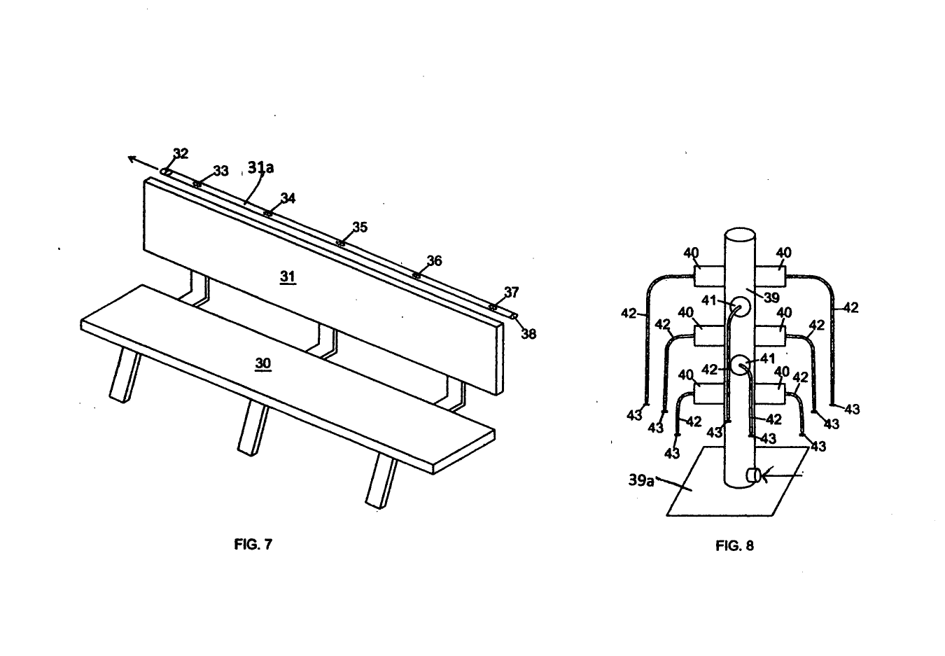

FIG. 4 is basically the same system as was explained with reference to FIG. 1. FIGS. 5 and represent front and back views of the T-shirt, respectively. The difference here is that this system will be incorporated in a T-shirt 15 whereby the circular tube 14 will be located in the bottom hem of the T-shirt 15. The T-shaped connectors 16, 17, 18 and 19 in this embodiment again establish the circular waistline tube while the air tubes 21, 22, 23 and 24 are upstanding from the circular tube 14. Again these 4 upstanding tubes will be located in their respective tunnels 25, 27, 28 and 29 in the T-shirt 15 and again will be located in a strategic and predetermined location. The tubes 22 and 23 will be located in the T-shirt and on its side areas and under the arm pit of the wearer. The tube 24 in the tunnel 27 is located in the front, FIG. 5, and the tube 21 is located in the tunnel 29 at the rear, FIG. 6, of the T-shirt. The circular tube 14 has a T-shaped connector located in the bottom hem of the shirt and has a connecting outlet 20 which will connected to an air source from the outside. It should also be noted the tunnels incorporated in said garments illustrated do not have to be of a continuous nature. They could just as well operate satisfactorily when installed in a discontinuous manner such as by segments. This is shown in FIG. 6 by the segments 29a, 29b and 29c. This will greatly contribute to the comfort of the wearer because this will render the garment more pliable.

FIG. 7 represents the location of an outside source of the required air. This location represents a bench which may be placed on the side lines of a football field. As mentioned above, this air cooling system is not intended to be in a continuous use. It is intended that a person when at rest may take advantage of this system. Any football player, who is temporarily at rest, may be located on the bench 30 shown in FIG. 7. The bench 30 has installed on the top of the back 31 an air tube 31a having a multiple of connecting ports 32, 33, 34, 36, 37 attached thereto. These ports are available to any and all players sitting on the bench to avail themselves to cooled air by connecting their respective T-shaped connectors on the circular tube on their waistline to these ports. The tube 31a may have a dimension of about 2″. The tube 31a has at one end a cap 38 that closes off the tube to the environment. The air intake into the tube 31a may also be reversed by admitting the cooled air into the capped port 38 and capping the other end 32.

FIG. 8 illustrates another embodiment of a source of conditioned air. This source consists of a stand-up tube 39 which may be strategically located in the firehouse or on the fire truck. This tube 39 may merely be located on a bottom platform 39a. The upstanding tube 39 has lateral outlets 40 and front outlets 41. Again the person at rest, in this case a fireman, may avail himself to any of the outlets having the tubes 42 depending therefrom by connecting any of these tubes 42 to their respective T-shaped connectors on the circular tube in the hem area of their respective garments, that is the short or the T-shirt or both at the same time. Naturally, any of the outlets 40 must have a disconnect, not shown, when not in use.

1. A cooling systems system incorporated into underwear including a circular tube located in a hem area of said underwear, said circular tube being assembled into said circle be by a multiple of T-shaped connectors, said T-shaped connectors having further each attached thereto an open-ended air tube, each of said open-ended air tubes is directed to a predetermined area of the body of the wearer, means for attaching each of said open-ended air tubes to an inside of said garment

2. The cooling system of claim 1, wherein said means for connecting are tunnels sewn into said garment.

3. The cooling system of claim 1 wherein said tunnels may be are discontinuous in segments.

4. The cooling system of claim 1, wherein said underwear is a short.

5. The cooling system of claim 4, wherein said open-ended air tubes are directed into a downward direction.

6. The cooling system of claim 1, wherein said underwear is a T-shirt.

7. The cooling system of claim 6, wherein said open-ended air tubes are directed into an upward direction.

8. The cooling system of claim 1 including a connector on said circular tube to a remote location of an air source.

9. The cooling system of claim 8, wherein said remote source of air is a bench located on a playing field.

10. The caroling system of claim 9, wherein said bench has a multiple of air outlets thereon to accommodate a multiple of players at any one time.

11. The cooling system of claim 9, wherein said remote source of air is an upstanding tube having a multiple of lateral outlets.

12. The cooling system of claim 11, wherein any of said lateral outlets can be connected to said outlet on said circular tube on said garment.

13. The cooling system of claim 11, wherein said upstanding tube is located in a location readily available to firemen.
